(19) United States
(12) Patent Application Publication
(10) Pub. No.: US 2018/0376478 A1
(43) Pub. Date: Dec. 27, 2018

(54) WIRELESS COMMUNICATION DEVICE AND WIRELESS COMMUNICATION METHOD

(71) Applicant: KABUSHIKI KAISHA TOSHIBA, Tokyo (JP)

(72) Inventors: Daiki YODA, Yokohama (JP); Daisuke UCHIDA, Kawasaki (JP); Koji AKITA, Yokohama (JP); Tomoya TANDAI, Tokyo (JP)

(73) Assignee: KABUSHIKI KAISHA TOSHIBA, Tokyo (JP)

(21) Appl. No.: 15/918,270

(22) Filed: Mar. 12, 2018

(30) Foreign Application Priority Data
Jun. 21, 2017 (JP) 2017-121426

(51) Int. Cl. H04W 72/04; H04L 25/02

(52) U.S. Cl. CPC H04W 72/0453; H04L 25/0204

(57) ABSTRACT

A wireless communication device according to an aspect of the present invention includes a transmitter, a receiver, and a signal processor. The transmitter transmits a first signal. The receiver receives a second signal which includes information indicating a transmission channel characteristic at the time of transmission of the first signal. The signal processor acquires the transmission channel characteristic at the time of transmission of the first signal from the second signal, estimates a reception channel characteristic at the time of reception of the second signal from the second signal, and estimates a transmission channel characteristic at a time later than a time associated with the acquired transmission channel characteristic on the basis of the acquired transmission channel characteristic and the estimated reception channel characteristic. The transmitter transmits a third signal on the basis of the estimated transmission channel characteristic.

### CROSS-REFERENCE TO RELATED APPLICATION(S)

This application is based upon and claims the benefit of priority from Japanese Patent Application No. 2017-121426, filed Jun. 21, 2017; the entire contents of which are incorporated herein by reference.

### FIELD

An embodiment relates to a wireless communication device and a wireless communication method.

### BACKGROUND

An adaptive modulation scheme has been proposed in order to compensate for a reduction of frequency-selectivity in wireless broadband communication which occupies a wide frequency band. For example, as the adaptive modulation scheme in wireless communication using Orthogonal Frequency Division Multiplexing (OFDM), a method in which a modulation scheme for each subcarrier is changed on the basis of a channel characteristic of the subcarrier is proposed.

For example, in a case where a first wireless communication device and a second wireless communication device perform wireless communication, the second wireless communication device estimates a channel characteristic on the basis of a signal transmitted by the first wireless communication device. The channel characteristic estimated by the second wireless communication device is fed back to the first wireless communication device. The first wireless communication device determines a modulation scheme for a transmission signal on the basis of the fed-back channel characteristic. In this manner, the modulation scheme corresponding to the channel characteristic is determined.

The fed-back channel characteristic, however, is a channel characteristic when the first wireless communication device transmits to the second wireless communication device. Hence, fed-back channel information does not indicate a current channel characteristic when the channel characteristic changes from moment to moment. Thus, even if modulation is performed on the basis of fed-back channel information, communication quality may deteriorate.

### BRIEF DESCRIPTION OF THE DRAWINGS

FIG. 1 is a conceptual diagram illustrating an example of a wireless communication system according to an embodiment of the present invention;

FIG. 2 is a chart illustrating a relationship between OFDM signal and channel characteristic;

FIG. 3 is a chart illustrating change in the relationship between OFDM signal and channel characteristic;

FIG. 4 is a chart illustrating an example of a schematic flowchart of overall processing by a wireless communication device according to the embodiment of the present invention;

FIG. 5 is a block diagram illustrating an example of an internal configuration of a transmission channel characteristic estimator;

FIG. 6 is a chart illustrating correlation between variation in transmission channel characteristic and variation in reception channel characteristic;

FIG. 7 is a chart for explaining a method for detecting a subcarrier with a high correlation value;

FIG. 8 is a chart for explaining variation in correlation value with difference between subcarriers to be compared;

FIG. 9 is a chart illustrating an example of a flowchart of a transmission channel characteristic estimation process; and

FIG. 10 is a chart for explaining effects of smoothing.

### DETAILED DESCRIPTION

A wireless communication device according to an embodiment of the present invention estimates a characteristic of a channel after signal transmission.

A wireless communication device according to an aspect of the present invention includes a transmitter, a receiver, and a signal processor. The transmitter transmits a first signal. The receiver receives a second signal which includes information indicating a transmission channel characteristic at the time of transmission of the first signal. The signal processor acquires the transmission channel characteristic at the time of transmission of the first signal from the second signal, estimates a reception channel characteristic at the time of reception of the second signal from the second signal, and estimates a transmission channel characteristic at a time later than a time associated with the acquired transmission channel characteristic on the basis of the acquired transmission channel characteristic and the estimated reception channel characteristic. The transmitter transmits a third signal on the basis of the estimated transmission channel characteristic.

An embodiment will be explained in detail below with reference to the accompanying drawings. The present invention is not limited to the embodiment.

### One Embodiment of Present Invention

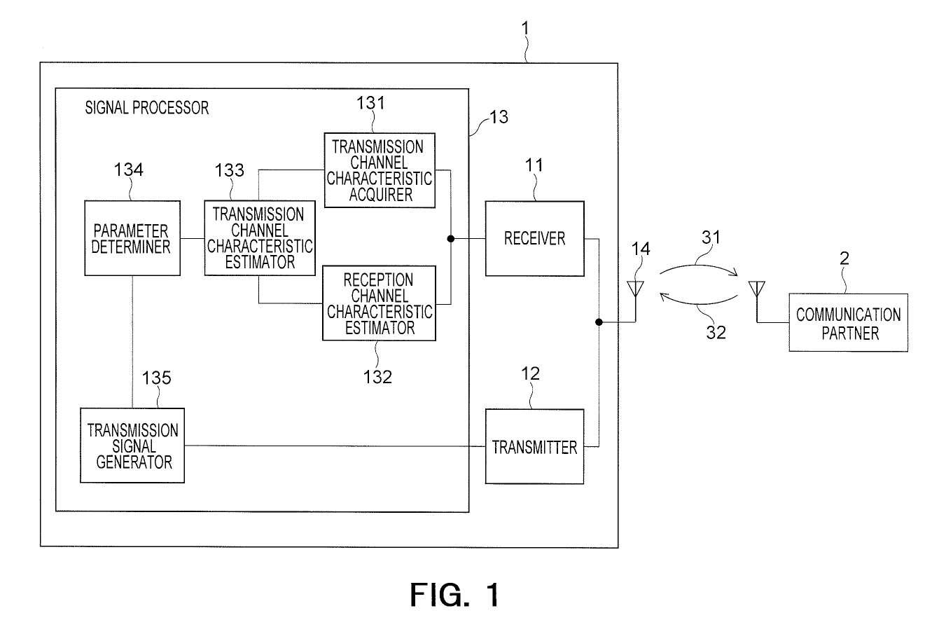

FIG. 1 is a conceptual diagram illustrating an example of a wireless communication system according to an embodiment of the present invention. The wireless communication system according to the present embodiment includes a wireless communication device 1 and a wireless communication device (hereinafter referred to as a communication partner) 2 which performs wireless communication with the wireless communication device 1. The wireless communication device 1 includes a receiver 11 which receives a signal, a transmitter 12 which transmits a signal, a signal processor 13 which performs processing on signals associated with transmission and reception, and an antenna 14 which at least transmits or receives radio waves. The signal processor 13 includes a transmission channel characteristic acquirer 131, a reception channel characteristic estimator 132, a transmission channel characteristic estimator 133, a parameter determiner 134, and a transmission signal generator 135.

Assume that the wireless communication device 1 according to the present embodiment perform full duplex communication using Frequency Division Duplex (FDD). The present description uses the wireless communication device 1 as a standard. A signal from the wireless communication device 1 to the communication partner 2 will be referred to as a transmission signal (a first signal and a third signal), and a signal from the communication partner 2 to the wireless communication device 1 will be referred to as a reception signal (a second signal).

A channel for a transmission signal will be referred to as a transmission channel, and a channel for a reception signal will be referred to as a reception channel. FIG. 1 illustrates arrival of a radio wave associated with a transmission signal from the antenna 14 at the communication partner 2 via a transmission channel indicated by an arrow 31 and arrival of a radio wave associated with a reception signal from the communication partner 2 at the antenna 14 via a reception channel indicated by an arrow 32.

Assume that the wireless communication device 1 according to the present embodiment performs transmission commensurate with a characteristic of the transmission channel. For example, a transmission scheme for a transmission signal may be changed in accordance with a characteristic of the transmission channel. For example, whether to use a multicarrier wireless communication scheme using a plurality of subcarriers as a transmission scheme may be determined. If a multicarrier wireless communication scheme is used as the transmission scheme, characteristics of the transmission channel and characteristics of the reception channel differ from subcarrier to subcarrier. For this reason, assume that the wireless communication device 1 performs transmission of a transmission signal that is commensurate with characteristics of the transmission channel for respective subcarriers. For example, the wireless communication device 1 may determine a modulation scheme for a subcarrier of a transmission signal on the basis of a characteristic of the transmission channel for the subcarrier.

Incidentally, a characteristic of the transmission channel will be hereinafter referred to as a transmission channel characteristic and a characteristic of the reception channel will be hereinafter referred to as a reception channel characteristic. A subcarrier for a transmission signal will be referred to as a transmission-side subcarrier, and a subcarrier for a reception signal will be referred to as a reception-side subcarrier.

Amplitude, power, a phase, a gain, or the like of signal is conceivable as each of a transmission channel characteristic and a reception channel characteristic. A characteristic to be used may be defined in advance in accordance with the purpose. For example, the amplitude or the power may be taken into consideration as a transmission channel characteristic, and a phase may not be taken into consideration.

In the description below, the wireless communication device 1 performs transmission using Orthogonal Frequency Division Multiplexing (OFDM) that is a multicarrier wireless communication scheme and subjects a transmission-side subcarrier to modulation on the basis of a transmission channel characteristic of the transmission-side subcarrier. Modulation commensurate with a transmission channel characteristic prevents deterioration in communication quality including an error rate characteristic, a communication speed, and the like.

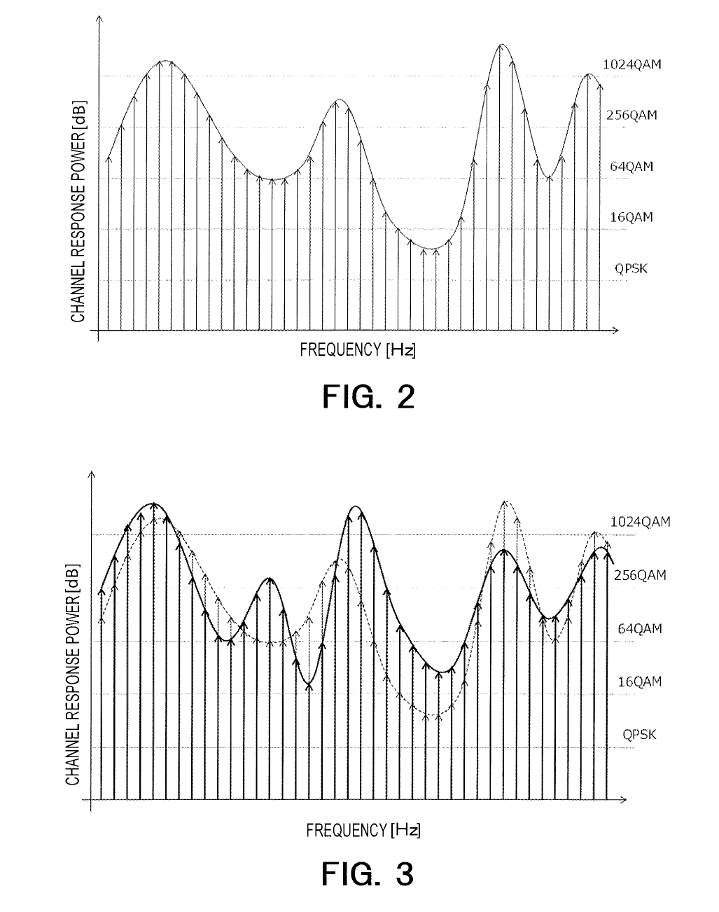

Influence of modulation commensurate with a transmission channel characteristic on communication quality will be described. FIG. 2 is a chart illustrating a relationship between OFDM signal and channel characteristic. The abscissa in FIG. 2 indicates a frequency of an OFDM signal while the ordinate indicates channel response power. The channel response power is a type of channel characteristic. Each arrow in FIG. 2 indicates a subcarrier and a modulation scheme for the subcarrier. A head of the arrow indicates the type (the number of signal points) of Quadrature Amplitude Modulation (QAM) to be applied to the subcarrier. In FIG. 2, a modulation scheme with a high modulation rate is assigned in accordance with magnitude of channel response power of a subcarrier.

An OFDM signal is a signal generated by assigning a signal to be modulated to each of subcarriers different in frequency and subjecting the signals to an inverse Fourier transform. As in the example in FIG. 2, a different modulation scheme may be used for each subcarrier.

In, e.g., a case where a delay wave or the like other than a direct wave is present in a channel, the response power may have undulations, as indicated by a curve in FIG. 2. Generally, a Signal-Power-to-Noise-Power Ratio (SNR) is lower at a frequency with lower power. Thus, at the frequency, an error rate of wireless communication is higher. A modulation scheme with a small number of signal points is characteristically unlikely to cause an error due to an increased distance between signal points.

Thus, as in the example in FIG. 2, a low-order modulation scheme is preferably used for a subcarrier with a low channel power characteristic, and a high-order modulation scheme is preferably used for a subcarrier with a high power characteristic. In the example in FIG. 2, Quadrature Phase Shift Keying (QPSK) is used for a subcarrier with lowest response power, and 1024-QAM is used for a subcarrier with highest response power. The change of a modulation scheme allows prevention of a reduction in communication quality.

Thus, deterioration in communication quality is prevented by changing a modulation scheme in accordance with a transmission channel characteristic. In the present embodiment, since two-way communication is performed at all time using different frequency bands for transmission and reception, as described above, a reception channel characteristic and a transmission channel characteristic are different. The wireless communication device 1 can estimate a reception channel characteristic on the basis of a reception signal using a known scheme. However, a transmission channel characteristic cannot be estimated with a reception signal alone. For this reason, the present embodiment assumes that the communication partner 2 estimates a transmission channel characteristic on the basis of a transmission signal and feeds back the estimated transmission channel characteristic to the wireless communication device 1. That is, the wireless communication device 1 receives a reception signal which includes information indicating a transmission channel characteristic.

Incidentally, transmission channel characteristics for all subcarriers need not be fed back. For example, transmission channel characteristics for some subcarriers may be fed back, and transmission channel characteristics for the remaining subcarriers may be complemented on the basis of the transmission channel characteristics of the subcarriers. Alternatively, an item not to be used as a transmission channel characteristic may not be fed back. For example, if an amplitude value or a power value of a signal is used as a channel characteristic, a phase need not be fed back.

A channel characteristic changes with a variation in a position of a reflection zone or the like around the antenna 14 and the wireless communication device 1. It takes time for a transmission channel characteristic to be fed back. A time period for feedback will be referred to as a feedback delay time period. The feedback delay time period includes a transmission propagation delay, a delay in processing by the communication partner 2, and a reception propagation delay. The term transmission propagation delay refers to a time period to arrival of a transmission signal at the communication partner 2. The term reception propagation delay refers to a time period to arrival of a reception signal from the communication partner 2 at the wireless communication device 1. The delay in processing by the communication partner 2 includes a time period for the communication partner 2 to perform a process of estimating a transmission channel characteristic and a time period for the communication partner 2 to perform a process of generating the reception signal.

If a transmission channel characteristic changes in a shorter time period than the feedback delay time period, a fed-back transmission channel characteristic does not indicate a transmission channel characteristic after change. Thus, even if modulation is performed on the basis of fed-back transmission channel information, the transmission channel information is inconsistent with a current transmission channel characteristic, and the communication quality deteriorates. In particular, the feedback delay time period increases with an increase in communication distance, which increases the possibility of deterioration in communication quality.

FIG. 3 is a chart illustrating change in the relationship between OFDM signal and channel characteristic. A dashed curve indicates a channel characteristic before change, and a solid curve indicates a channel characteristic after change.

For example, a subcarrier which has highest power and uses 1024-QAM before change preferably uses 256-QAM after change. A subcarrier which has lowest power and uses QPSK before change has power sufficient to use 16-QAM after change. That is, if communication is performed by a previous modulation scheme even after change, a subcarrier highest in power before change suffers from deterioration in error rate characteristic, and a subcarrier lowest in power before change suffers from a reduction in throughput. Thus, a modulation scheme for a transmission-side subcarrier is preferably adjusted in accordance with a variation in transmission channel characteristic.

Thus, in a wireless communication device which changes a transmission scheme in accordance with a transmission channel characteristic, understanding of a current transmission channel characteristic with maximum possible accuracy results in improvement in communication quality. Hence, the wireless communication device 1 according to the present embodiment estimates a transmission channel characteristic after change without using a fed-back transmission channel characteristic.

Incidentally, the components illustrated in FIG. 1 are intended to estimate a transmission channel characteristic after change. Other components necessary for wireless communication are omitted. That is, the wireless communication device 1 may include other components. For example, the signal processor 13 of the wireless communication device 1 may include a storage which is implemented by a memory or a storage device.

An internal configuration of the signal processor 13 in the wireless communication device 1 will be described. The transmission channel characteristic acquirer 131 acquires, from a reception signal, a transmission channel characteristic at the time of transmission of a transmission signal. Incidentally, a transmission time associated with the transmission channel characteristic included in the reception signal is a time obtained by subtracting the feedback delay time period from a time of reception of the reception signal.

The reception channel characteristic estimator 132 estimates, from the reception signal, a reception channel characteristic at the time of reception of the reception signal. A well-known scheme may be used as a method for calculating the reception channel characteristic from the reception signal. Incidentally, the same applies to a method by which the communication partner 2 estimates a transmission channel characteristic from the transmission signal.

The transmission channel characteristic estimator 133 estimates a transmission channel characteristic at a time later than the time associated with the acquired transmission channel characteristic, on the basis of the transmission channel characteristic acquired by the transmission channel characteristic acquirer 131 and the reception channel characteristic estimated by the reception channel characteristic estimator 132.

For example, assume that a transmission signal is transmitted at a first time, and a reception signal which includes information indicating a transmission channel characteristic at the first time is received at a second time which is later by about the feedback delay time period than the first time. Also, assume that a transmission signal is also transmitted at the second time, and a reception signal which includes information indicating a transmission channel characteristic at the second time is received at a third time which is later by about the feedback delay time period than the second time. In such the case, the transmission channel characteristic estimator 133 acquires the transmission channel characteristics at the first and second times from the transmission channel characteristic acquirer 131 and acquires reception channel characteristics at the first, second, and third times from the reception channel characteristic estimator 132. The transmission channel characteristic estimator 133 estimates a transmission channel characteristic at the third time on the basis of the transmission channel characteristics and the reception channel characteristics. Details of the estimation will be described together with an internal configuration of the transmission channel characteristic estimator 133.

Thus, a transmission channel characteristic estimated by the transmission channel characteristic estimator 133 is newer than a transmission channel characteristic acquired by the transmission channel characteristic acquirer 131. Hence, a transmission channel characteristic estimated by the transmission channel characteristic estimator 133 can be a transmission channel characteristic after change. Accordingly, modulation scheme determination based on a transmission channel characteristic estimated by the transmission channel characteristic estimator 133 leads more to improvement in communication quality than modulation scheme determination based on a fed-back transmission channel characteristic.

The parameter determiner 134 generates a parameter for modulation on the basis of the estimated transmission channel characteristic. The parameter may be a modulation scheme for a transmission-side subcarrier. For example, as described with reference to FIG. 3, a modulation scheme for each transmission-side subcarrier, i.e., the number of signal points in QAM may be determined on the basis of channel response power of the transmission-side subcarrier. As described above, a transmission scheme may be determined on the basis of an estimated transmission channel characteristic.

The transmission signal generator 135 generates a signal on the basis of the parameter generated by the parameter determiner 134. For example, the transmission signal generator 135 may generate an OFDM signal by subjecting transmission-side subcarriers to modulation on the basis of modulation schemes for the respective transmission-side subcarriers determined by the parameter determiner 134. The generated signal is transmitted to the communication partner 2 via the transmitter 12. Since a transmission signal commensurate with a transmission channel characteristic after change is transmitted to the communication partner 2, as described above, deterioration in characteristic due to inconsistency with an actual transmission channel characteristic is unlikely to occur.

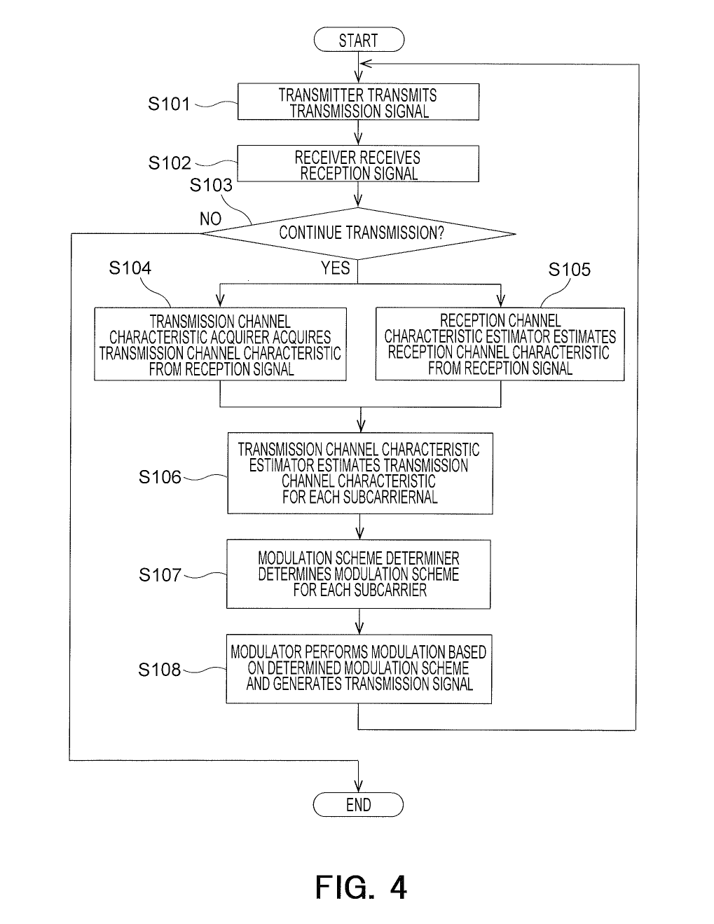

The flow of processing by the components will be described. FIG. 4 is a chart illustrating an example of a schematic flowchart of overall processing by the wireless communication device according to the embodiment of the present invention.

The transmitter 12 transmits a transmission signal (S101). After that, the receiver 11 receives a reception signal (S102). If transmission is not continued (NO in S103), transmission channel characteristic estimation is unnecessary, and the flow ends. On the other hand, if transmission is continued (YES in S103), the transmission channel characteristic acquirer 131 acquires a transmission channel characteristic from the reception signal (S104), and the reception channel characteristic estimator 132 estimates a reception channel characteristic from the reception signal (S105).

The transmission channel characteristic estimator 133 estimates a transmission channel characteristic for each transmission-side subcarrier on the basis of the acquired transmission channel characteristic and the estimated reception channel characteristic (S106). The parameter determiner 134 determines a modulation scheme for each transmission-side subcarrier (S107). A modulator performs modulation based on the modulation schemes for the respective transmission-side subcarriers and generates a transmission signal (S108). With this modulation, wireless communication with an adaptive modulation scheme is implemented. The flow returns to the process in S101, and the transmitter 12 transmits the transmission signal. The processes are repeated until termination of transmission.

Incidentally, the flowchart is just an example and the order of processes is not particularly limited as long as a necessary processing result can be obtained. For example, the process in S104 and the process in S105 may be performed in parallel, as in FIG. 4, or may be performed in order. Processing results of respective processes may be sequentially stored in the storage (not illustrated), and each component may refer to the storage and acquire a processing result.

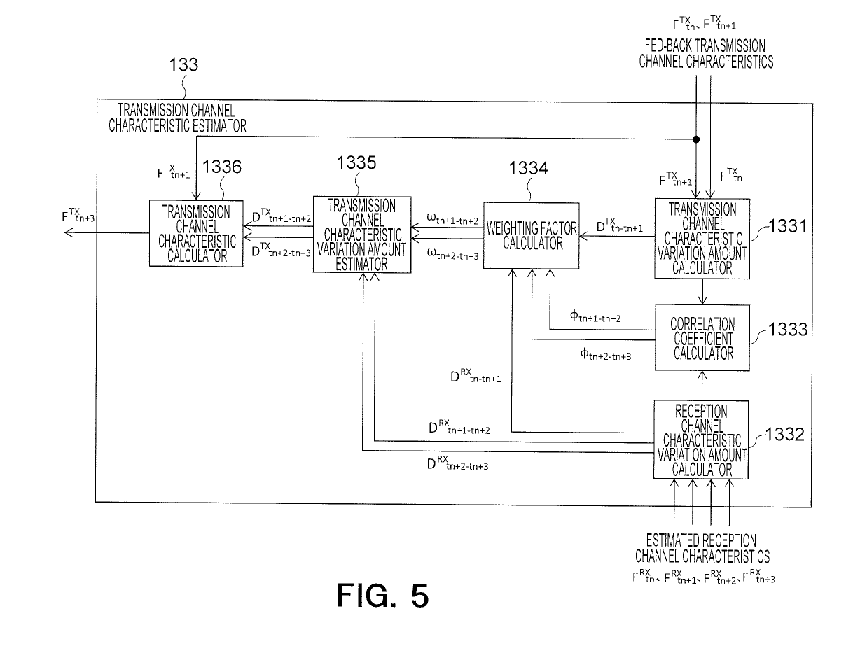

An estimation method of the transmission channel characteristic estimator 133 will be described. FIG. 5 is a block diagram illustrating an example of the internal configuration of the transmission channel characteristic estimator 133. The transmission channel characteristic estimator 133 includes a transmission channel characteristic variation amount calculator 1331, a reception channel characteristic variation amount calculator 1332, a correlation coefficient calculator 1333, a weighting factor calculator 1334, a transmission channel characteristic variation amount estimator 1335, and a transmission channel characteristic calculator 1336.

Each arrow illustrated in FIG. 5 indicates an individual piece of information (a value) to be input to or output from a component. Incidentally, the number of arrows depends on the feedback delay time period. The example in FIG. 5 assumes that the feedback delay time period corresponds to two predetermined time intervals. A time later by a predetermined time interval than a time tₙ (n is an integer) is denoted by tₙ₊₁. Since the feedback delay time period corresponds to two predetermined time intervals in the example in FIG. 5, a transmission channel characteristic associated with a transmission signal transmitted at the time tₙ can be said to be included in a reception signal received at a time tₙ₊₂.

Assume in the example in FIG. 5 that communication starts at the time tₙ and that a time tₙ₊₃ is reached. That is, assume that respective reception signals are received at the times tₙ, tₙ₊₁, tₙ₊₂, and tₙ₊₃. In this case, the transmission channel characteristic acquirer 131 acquires two transmission channel characteristics, a transmission channel characteristic F^{TX}ₜₙ at the time tₙ from the reception signal at the time tₙ₊₂ and a transmission channel characteristic F^{TX}ₜₙ₊₁ at the time tₙ₊₁ from the reception signal at the time tₙ₊₃. Incidentally, the superscript “TX” means association with a transmission side. The reception channel characteristic estimator 132 estimates four reception channel characteristics, reception channel characteristics F^{RX}ₜₙ, F^{RX}ₜₙ₊₁, F^{RX}ₜₙ₊₂, and F^{RX}ₜₙ₊₃ from the reception signals at the respective times tₙ to tₙ₊₃. Incidentally, the superscript “RX” means association with a reception side.

As illustrated in FIG. 5, the transmission channel characteristics F^{TX}ₜₙ and F^{TX}ₜₙ₊₁ and the reception channel characteristics F^{RX}ₜₙ, F^{RX}ₜₙ₊₁, F^{RX}ₜₙ₊₂, and F^{RX}ₜₙ₊₃ are input to the transmission channel characteristic estimator 133. The transmission channel characteristic estimator 133 outputs a transmission channel characteristic F^{TX}ₜₙ₊₃ at the time tₙ₊₃ on the basis of the inputs.

Incidentally, as described above, each of a transmission channel characteristic and a reception channel characteristic is present for each subcarrier. For this reason, each of transmission channel characteristics and reception channel characteristics to be input and transmission channel characteristics to be output is present for each subcarrier. A description will be given without distinction between subcarriers for convenience of the description.

The transmission channel characteristic F^{TX}ₜₙ₊₃ at the time tₙ₊₃ is represented as a sum of the transmission channel characteristic F^{TX}ₜₙ₊₁ at the time tₙ₊₁, the amount of variation in transmission channel characteristic from the time tₙ₊₁ to the time tₙ₊₂, and the amount of variation in transmission channel characteristic from the time tₙ₊₂ to the time tₙ₊₃. If the amount of variation in transmission channel characteristic from the time tₙ to the time tₙ₊₁ is represented as a transmission channel characteristic variation amount D^{TX}ₜₙ₋ₜₙ₊₁, the estimated transmission channel characteristic F^{TX}ₜₙ₊₃ is represented as follows:

[Expression 1]

Fₜ_{ₙ₊₃}^{TX}=Fₜ_{ₙ₊₁}^{TX}+Dₜ_{ₙ₊₁}₋ₜ_{ₙ₊₂}^{TX}+Dₜ_{ₙ₊₂}₋ₜ_{ₙ₊₃}^{TX} (1)

The transmission channel characteristic variation amount D^{TX}ₜₙ₋ₜₙ₊₁ is estimated on the basis of a reception channel characteristic variation amount D^{RX}ₜₙ₋ₜₙ₊₁. This is because correlation is seen between variation in transmission channel characteristic and variation in reception channel characteristic.

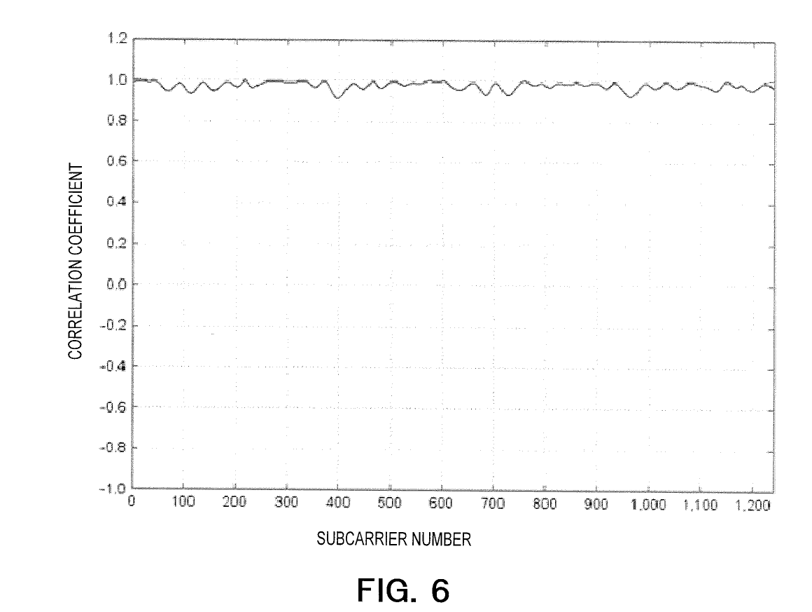

FIG. 6 is a chart illustrating correlation between variation in transmission channel characteristic and variation in reception channel characteristic. Correlation between variations due to passage of an obstacle, such as a bird, in a channel is illustrated in FIG. 6. A frequency band for a transmission signal is the 70 GHz band, and a frequency band for a reception signal is the 80 GHz band. The abscissa indicates a number of each transmission-side subcarrier. Assume that the number of subcarriers is 1240. The ordinate indicates a correlation coefficient calculated for each transmission-side subcarrier. The example in FIG. 6 illustrates a largest correlation value among a plurality of correlation values calculated by comparing a transmission-side subcarrier with each of a plurality of reception-side subcarriers as a correlation coefficient for the transmission-side subcarrier.

A correlation value ϕ between a transmission channel characteristic variation amount and a reception channel characteristic variation amount for each of a time t₁ to a time t_{N} (N is an integer not less than 2) is calculated by, for example, the following:

$$\begin{matrix}[ Expression 2 ] & \\ ∅ ( {f}^{TX} , {f}^{RX} ) = \frac{{Σ}_{1}^{N} ( {D}_{{t}_{n} - {t}_{n + 1}}^{TX} ( {f}^{TX} ) {D}_{{t}_{n} - {t}_{n + 1}}^{RX} ( {f}^{RX} ) )}{\sqrt{{{Σ}_{1}^{N} ( {D}_{{t}_{n} - {t}_{n + 1}}^{TX} ( {f}^{TX} ) )}^{2} {Σ}_{1}^{N} ( {{D}_{{t}_{n} {t}_{n + 1}}^{RX} ( {f}^{RX} )}^{2}}} & ( 2 )\end{matrix}$$

The symbol f^{TX} denotes a frequency of a transmission-side subcarrier. The symbol f^{RX} denotes a frequency of a reception-side subcarrier to be compared. Thus, a correlation value is calculated for each reception-side subcarrier with respect to a given transmission-side subcarrier. A correlation coefficient and a corresponding reception-side subcarrier are determined on the basis of the correlation values. Incidentally, although a maximum value among correlation values is adopted as a correlation coefficient in FIG. 6, the present invention is not limited to a maximum value. An average value or a median value may be adopted. For example, a reception-side subcarrier having a correlation value set as a correlation coefficient may be set as a corresponding reception-side subcarrier.

As can be seen from the chart, a correlation coefficient close to 1 is obtained for each of almost all transmission-side subcarriers. Thus, correlation between variation in transmission channel characteristic and variation in reception channel characteristic is very high. For this reason, a variation in transmission channel characteristic can be estimated on the basis of a variation in reception channel characteristic.

As indicated by Equation 2, correlation values differ widely depending on which one of reception-side subcarriers is compared. Thus, as described above, a reception-side subcarrier with a high correlation value may be retrieved and be recognized as a corresponding reception-side subcarrier. Alternatively, instead of individually retrieving a corresponding subcarrier for each transmission-side subcarrier, a sequence of subcarriers may be treated as a group, and comparison may be performed on a group-by-group basis.

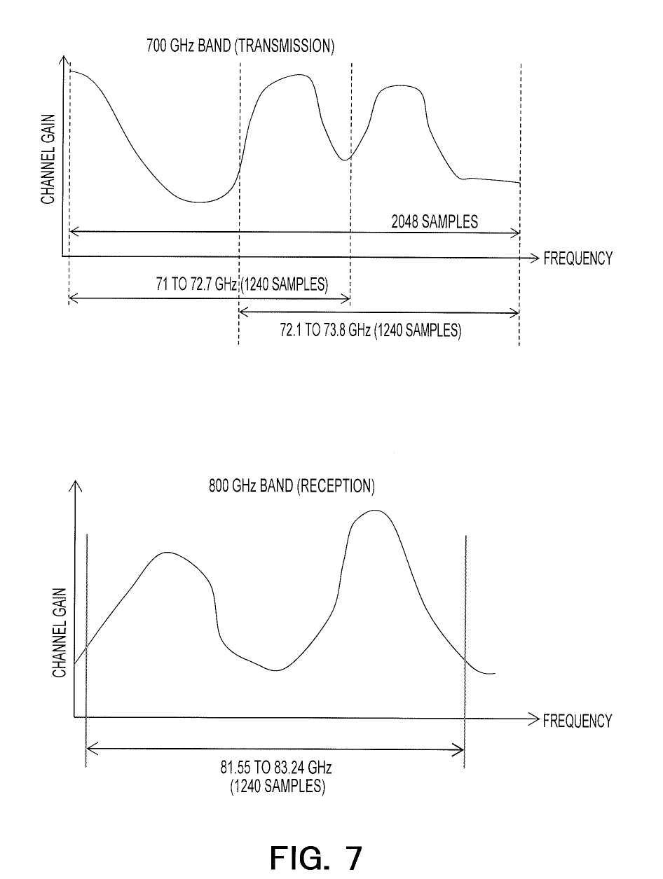

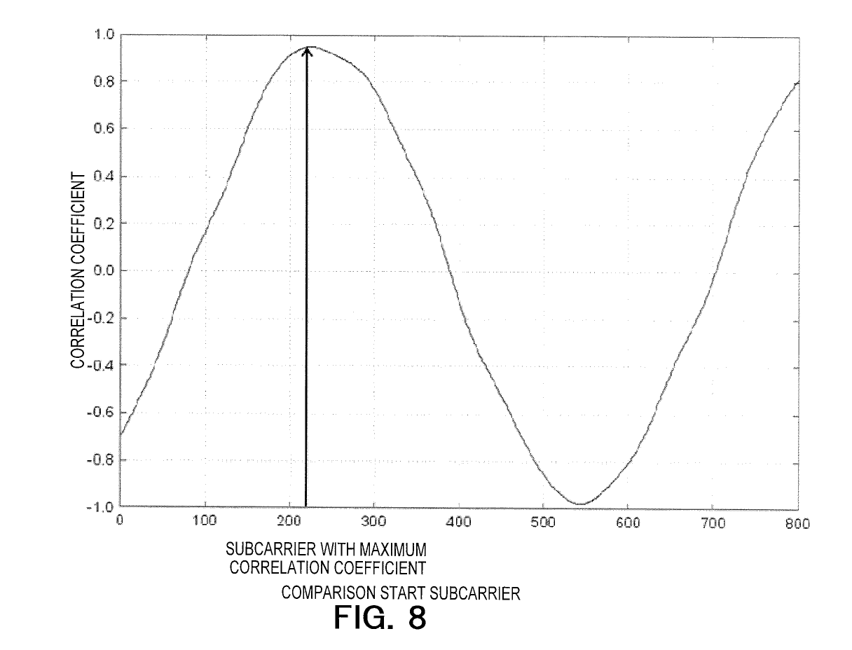

FIG. 7 is a chart illustrating an example of a method for detecting a subcarrier with a high correlation value. A curve associated with variation in transmission channel is illustrated on an upper side of FIG. 7. In the example in FIG. 7, variation in channel gain is illustrated. Assume in the example in FIG. 7 that there are 2048 transmission-side subcarriers. A curve associated with variation in reception channel to be compared is illustrated on a lower side of FIG. 7. Assume in the example that the number of reception-side subcarriers to serve as a comparison target is 1024.

a sequence of first to 1024th transmission-side subcarriers at frequencies from 71 to 72.7 GHz among the 2048 subcarriers for a transmission signal is set as a first comparison target group. The first comparison target group is compared with a sequence of first to 1024th reception-side subcarriers at frequencies from 81.55 to 83.24 GHz.

Assume that the number of reception-side subcarriers to be compared with one transmission-side subcarrier is one and that comparison is performed in order of in-group frequency. For example, the first reception-side subcarrier is compared with the first transmission-side subcarrier, and an m-th (m is an integer not less than 2 and not more than 1024) reception-side subcarrier is compared with an m-th transmission-side subcarrier. A correlation value is calculated for each pair of subcarriers compared. A correlation coefficient for the first comparison target group is calculated on the basis of a plurality of calculated correlation values.

A transmission-side subcarrier frequency range to be compared is then shifted. Transmission-side subcarriers within the shifted range are compared with the group of reception-side subcarriers described above. For example, if the frequency range is shifted by one subcarrier, a sequence of second to 1025th transmission-side subcarriers is set as a second comparison target group. The transmission-side subcarriers are compared with the reception-side subcarriers, and a correlation coefficient for the second comparison target group is calculated. In this case, an (m+1)-th transmission-side subcarrier is compared with the m-th reception-side subcarrier.

Thus, a plurality of comparison target groups are formed by shifting the transmission-side subcarrier frequency range to be compared, and a plurality of correlation coefficients are calculated for the respective comparison target groups. One is selected from among the plurality of calculated correlation coefficients on the basis of a predetermined condition, and a corresponding comparison target group is determined. As a result, corresponding reception-side subcarriers are determined.

The predetermined condition may be freely set as long as it enhances accuracy of transmission channel characteristic estimation. For example, a largest correlation value may be selected. Incidentally, although a comparison target group is formed by shifting the transmission-side subcarrier frequency range to be compared by one subcarrier in a frequency-increasing direction in the above description, the number of subcarriers, by which the frequency range is to be shifted, may be freely defined as appropriate. The number of subcarriers, by which the frequency range is to be shifted, will be referred to as a shift width.

FIG. 8 is a chart for explaining variation in correlation value with difference between subcarriers to be compared. FIG. 8 illustrates a correlation value when a reception-side subcarrier range to be compared is fixed, and a comparison target group is formed by shifting the transmission-side subcarrier range to be compared by one subcarrier, as described with reference to FIG. 7. That is, the shift width is 1.

It is clear from the example in FIG. 8 that a correlation value is highest and is almost 1 when the transmission-side subcarrier frequency range to be compared is shifted from a start point by 210 subcarriers. That is, FIG. 8 indicates that high correlation can be detected when 211th to 1234th transmission-side subcarriers are compared with the first to 1024th reception-side subcarriers. By detecting a subcarrier suitable for comparison in this manner, a transmission channel characteristic variation amount can be estimated with high accuracy from a reception channel characteristic variation amount. Incidentally, a deviation in number of a transmission-side subcarrier from a reception-side subcarrier will be referred to as a deviation position. In the example in FIG. 8, the deviation position is 210.

Incidentally, since the frequency band for a transmission signal and the frequency band for a reception signal are different, as described above, speed of phase rotation of a transmission signal and speed of phase rotation of a reception signal are different. For this reason, a subcarrier position with a maximum correlation value can vary with passage of time. Thus, when a predetermined time period elapses, a corresponding subcarrier may be calculated again. This allows comparison with a suitable subcarrier even after a lapse of time and maintenance of high-accuracy estimation.

Incidentally, a correlation coefficient may be used as a calculation parameter at the time of estimation of the transmission channel characteristic variation amount D^{TX}ₜₙ₋ₜₙ₊₁. More specifically, a transmission channel characteristic variation amount D^{TX} may be calculated by multiplying a different parameter by a correlation coefficient. For this reason, if correlation is low, the amount of variation of an estimated value in question from a fed-back transmission channel characteristic is small. In this manner, a fed-back transmission channel characteristic and an estimated transmission channel characteristic after change may be prevented from differing greatly due to abnormal correction.

Incidentally, although a correlation value between subcarriers is expected to be actually high, the correlation value may momentarily become low due to influence of noise to cause an error. To avoid influence of such a noise error, respective correlation values may be calculated at a plurality of time intervals, and an average value of the plurality of calculated correlation values may be used for transmission channel characteristic estimation. An average of correlation values calculated at a plurality of time intervals will be referred to as a time-average correlation value.

On the other hand, use of a time-average correlation value may lower the accuracy of transmission channel characteristic estimation in such a case that correlation value varies greatly in a short time period. In this case, correlation values obtained at specific time intervals may be used instead of using a time-average correlation value. Alternatively, instead of calculating a time-average correlation value by a simple average method, a time-average correlation value may be calculated by weighting correlation values at time intervals closer to a current time. Use of a time-average correlation value based on weighting makes it possible to reduce influence of a noise error while responding to a sharp temporal variation.

Thus, a reception-side subcarrier corresponding to a transmission-side subcarrier is determined on the basis of a correlation coefficient. The amount of variation in a transmission channel characteristic for a transmission-side subcarrier is estimated on the basis of the calculated amount of variation in a transmission channel characteristic for a transmission-side subcarrier and the calculated amounts of variation in a reception channel characteristic for a corresponding reception-side subcarrier. Examples of an equation of calculation of the amount of variation in a transmission channel characteristic for a transmission-side subcarrier are given by:

$$\begin{matrix}[ Expression 3 ] & \\ {D}_{{t}_{n + 1} - {t}_{n + 2}}^{TX} = {D}_{{t}_{n + 1} - {t}_{n + 2}}^{RX} \times \frac{{D}_{{t}_{n} - {t}_{n + 1}}^{TX}}{{D}_{{t}_{n} - {t}_{n + 1}}^{RX}} \times {∅}_{{t}_{n + 1} - {t}_{n + 1}} & ( 3 ) \\ {D}_{{t}_{n + 2} - {t}_{n + 3}}^{TX} = {D}_{{t}_{n + 2} - {t}_{n + 3}}^{RX} \times \frac{{D}_{{t}_{n} - {t}_{n + 1}}^{TX}}{{D}_{{t}_{n} - {t}_{n + 1}}^{RX}} \times {∅}_{{t}_{n + 2} - {t}_{n + 3}} & ( 4 )\end{matrix}$$

The transmission channel characteristic variation amount D^{TX}ₜₙ₋ₜₙ₊₁ is calculated by calculating a difference between the two input transmission channel characteristics F^{TX}ₜₙ and F^{TX}ₜₙ₊₁. The reception channel characteristic variation amount D^{RX}ₜₙ₋ₜₙ₊₁ is calculated by calculating a difference between the two input reception channel characteristics F^{RX}ₜₙ and F^{RX}ₜₙ₊₁. A reception channel characteristic variation amount D^{RX}ₜₙ₊₂₋ₜₙ₊₃ is calculated by calculating a difference between the two input reception channel characteristics F^{RX}ₜₙ₊₂ and F^{RX}ₜₙ₊₃. The correlation coefficient ϕ can be calculated by Equation 2 described above. Thus, transmission channel characteristic variation amounts D^{TX}ₜₙ₊₁₋ₜₙ₊₂ and D^{TX}ₜₙ₊₂₋ₜₙ₊₃ can be calculated. The estimated transmission channel characteristic F^{TX}ₜₙ₊₃ is calculated using Equation 1.

Incidentally, a product of a ratio of a transmission channel characteristic variation amount to a reception channel characteristic variation amount for the same time interval and a correlation coefficient will be referred to as a weighting factor ω. That is, Equation 3 is represented using the weighting factor ω, the following holds:

[Expression 4]

Dₜ_{ₙ₊₁}₋ₜ_{ₙ₊₂}^{TX}=Dₜ_{ₙ₊₁}₋ₜ_{ₙ₊₂}^{RX}×ωₜ_{ₙ₊₁}₋ₜ_{ₙ₊₂} (5)

Incidentally, even if correlation between a reception channel characteristic variation amount and a transmission channel characteristic variation amount is high, a reception channel characteristic variation amount is not added, and an estimated transmission channel characteristic variation amount is added, as indicated by Equation 1. This is because a correlation coefficient serves as a guide for judging whether a direction of variation is the same but is irrelevant to whether the amount of variation is the same.

Incidentally, since a correlation value increases or decreases with passage of time, a corresponding subcarrier may be preferably changed in, e.g., a case where an elapsed time period exceeds a predetermined length. Thus, a subcarrier corresponding to a transmission-side subcarrier may be different for each predetermined time interval. For example, a reception-side subcarrier used to calculate the transmission channel characteristic variation amount D^{TX}ₜₙ₊₁₋ₜₙ₊₂ and a reception-side subcarrier used to calculate the transmission channel characteristic variation amount D^{TX}ₜₙ₊₂₋ₜₙ₊₃ may be different. Comparison between subcarriers with high correlation makes it possible to keep the accuracy of transmission channel characteristic estimation high.

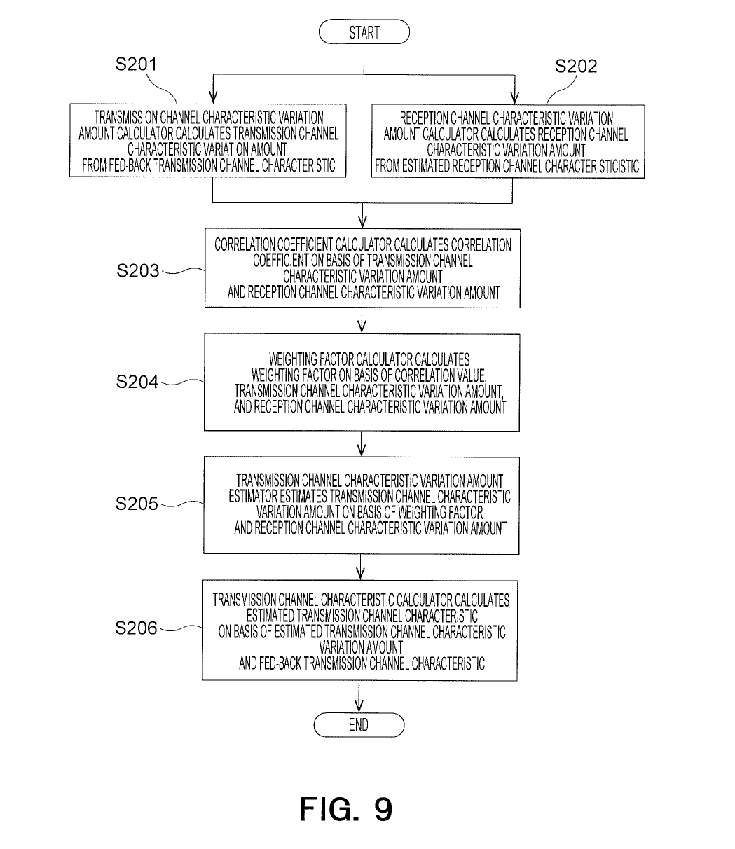

Processing by the components will be described with reference to the flow of the processing. FIG. 9 is a chart illustrating an example of a flowchart of a transmission channel characteristic estimation process. The process is performed for each transmission-side subcarrier, and a transmission channel characteristic for the transmission-side subcarrier is estimated.

The transmission channel characteristic variation amount calculator 1331 calculates a transmission channel characteristic variation amount from fed-back transmission channel characteristics (S201). The transmission channel characteristic variation amount can be calculated on the basis of a transmission channel characteristic acquired in the process last time and the transmission channel characteristic acquired in the process this time. Incidentally, all necessary transmission channel characteristics may be requested from the transmission channel characteristic acquirer 131. A previously acquired transmission channel characteristic may be stored in the storage.

The reception channel characteristic variation amount calculator 1332 calculates reception channel characteristic variation amounts (S202). The reception channel characteristic variation amounts can be calculated on the basis of reception channel characteristics sent from the reception channel characteristic estimator 132 thus far and a reception channel characteristic sent from the reception channel characteristic estimator 132 in the process this time. All necessary reception channel characteristics may be requested from the reception channel characteristic estimator 132. A previously acquired reception channel characteristics may be stored in the storage.

The correlation coefficient calculator 1333 determines a reception-side subcarrier corresponding to a transmission-side subcarrier on the basis of the calculated transmission channel characteristic variation amount and reception channel characteristic variation amounts and calculates correlation coefficients (S203).

The weighting factor calculator 1334 calculates weighting factors on the basis of the calculated correlation values, transmission channel characteristic variation amount, and reception channel characteristic variation amount (S204).

The transmission channel characteristic variation amount estimator 1335 estimates transmission channel characteristic variation amounts on the basis of the weighting factors and the reception channel characteristic variation amounts (S205).

The transmission channel characteristic calculator 1336 calculates a transmission channel characteristic by adding up the fed-back transmission channel characteristic and the transmission channel characteristic variation amounts estimated by the transmission channel characteristic variation amount estimator 1335

(S206). As described above, a transmission channel characteristic at a time later than a time associated with a fed-back transmission channel characteristic is estimated.

Incidentally, although a case where high correlation can be confirmed has been described above, a reception-side subcarrier with a high correlation value with a transmission-side subcarrier may not be extracted. In this case, it can be said that there is no sufficient correlation between a transmission channel characteristic variation amount and a reception channel characteristic variation amount. If transmission channel characteristic estimation is performed in the case, accuracy of an estimated transmission channel characteristic is likely to be low.

Accordingly, if a correlation coefficient for a transmission-side subcarrier is below a threshold associated with a correlation coefficient, transmission channel characteristic estimation may not be performed. Since a transmission channel characteristic variation amount is not estimated, addition of an estimated transmission channel characteristic variation amount is not performed. A modulation parameter may be determined on the basis of a value of a fed-back transmission channel characteristic without change. This allows avoidance of a large estimation error.

Incidentally, a weighting factor calculated by the weighting factor calculator 1334 uses a ratio having a transmission channel characteristic variation amount as a numerator and a reception channel characteristic variation amount as a denominator and may take an abnormally high value. Hence, when an absolute value of a difference between a weighting factor for a given subcarrier and a weighting factor for a previous or subsequent subcarrier is not less than a predetermined value, multiplication by the weighting factor need not be performed for the subcarrier at the time of estimation of a transmission channel characteristic variation amount. This allows a reduction in the number of transmission channel characteristics having an abnormal value and prevention of a reduction in accuracy of estimation.

When not a weighting factor but a transmission channel characteristic variation amount estimated by the transmission channel characteristic variation amount estimator 1335 exceeds a threshold associated with a transmission channel characteristic variation amount, transmission channel characteristic estimation may not be performed. Since a transmission channel characteristic variation amount is not estimated, addition of an estimated transmission channel characteristic variation amount is not performed. A modulation parameter may be determined on the basis of a value of a fed-back transmission channel characteristic without change.

When the number of transmission-side subcarriers, for which weighting factor multiplication is not performed or transmission channel characteristic estimation is not performed, exceeds a predetermined number, it may be judged that the accuracy of transmission channel characteristic estimation is low, and transmission channel characteristics for all transmission-side subcarriers may not be estimated. If a transmission channel characteristic is not estimated, modulation may be performed using a fed-back transmission channel characteristic. This allows prevention of a situation in which estimation increases a load on the wireless communication device 1 despite the inability of high-accuracy estimation.

To improve communication reliability, a modulation rate for a transmission-side subcarrier, for which estimation accuracy is judged to be low, may be adjusted. Change of a modulation scheme to one with a low modulation rate makes errors unlikely to occur. For example, if a corresponding reception-side subcarrier cannot be extracted, if a weighting factor exceeds a threshold, and in other cases, a modulation rate for a transmission-side subcarrier is made lower than a predetermined modulation rate. For example, 64-QAM may be set as the predetermined modulation rate, and modulation by QPSK or 16-QAM may be performed for the corresponding transmission-side subcarrier in question.

A modulation scheme may be adjusted for all transmission-side subcarriers. If it is judged that transmission channel characteristics for all transmission-side subcarriers are not estimated, QPSK may be set as a modulation scheme for all the subcarriers. This setting can make errors infinitesimally unlikely to occur. Alternatively, if the accuracy of transmission channel characteristic estimation is judged to be low, a modulation scheme to be applied to all subcarriers may be changed to a modulation scheme lower in modulation rate than a modulation scheme to be applied in the absence of adjustment. For example, a case is conceivable where a modulation scheme for a given transmission-side subcarrier which is 256-QAM before adjustment is changed to 64-QAM one level lower in modulation rate because the accuracy of transmission channel characteristic estimation is judged to be low. This reduces a transmission rate but allows enhancement of the communication reliability.

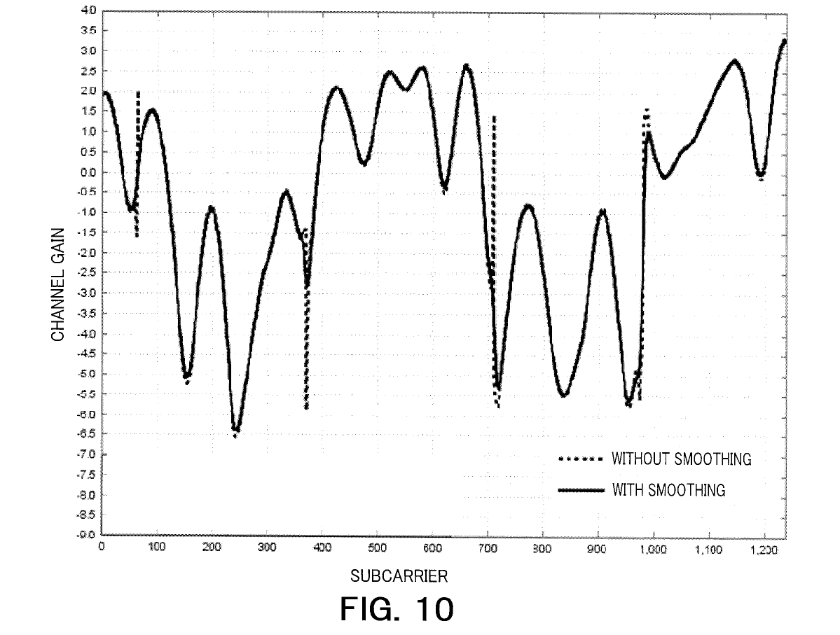

Smoothing may be performed on an estimated transmission channel characteristic. FIG. 10 is a chart for explaining effects of smoothing. A dashed curve indicates a channel gain for each subcarrier in a case where smoothing is not performed. A solid curve indicates a channel gain for each subcarrier in a case where smoothing is performed. Incidentally, the curves are both based on a correlation value, a value of a weighting factor, and the like and a value regarded as an abnormal value among estimation values of transmission channel characteristics after change is already omitted.

A result of the case without smoothing shows that the curve rises or falls sharply at some points in the graph due to influence of an abnormal value. Even if a transmission channel characteristic can be estimated with high accuracy for each of most transmission-side subcarriers, estimated transmission channel characteristics for some subcarriers may often deviate greatly. Hence, in the absence of smoothing, such a rise or fall is seen.

On the other hand, a result of the case with smoothing shows that influence of an abnormal value is greatly reduced. A large difference in transmission channel characteristic between adjacent subcarriers is not commonly seen. For this reason, influence of an abnormal value can be sufficiently reduced by smoothing.

As described above, the wireless communication device 1 according to the present embodiment estimates a transmission channel characteristic at a time later than a time associated with a fed-back transmission channel characteristic on the basis of the fed-back transmission channel characteristic and an estimated reception channel characteristic. A transmission signal is transmitted on the basis of the estimated transmission channel characteristic. Therefore, the wireless communication device 1 according to the present embodiment can prevent a reduction in communication quality more than in a case where transmission is performed on the basis of a fed-back transmission channel characteristic.

Incidentally, a component of the wireless communication device 1 according to the present embodiment may be implemented as a piece of dedicated hardware, such as an integrated circuit (IC) bearing a processor and the like. For example, the wireless communication device 1 may include a reception circuit which implements the receiver 11, a transmission circuit which implements the transmitter 12, and a processing (control) circuit which implements the signal processor 13. An internal configuration of the signal processor 13 may be implemented by a dedicated circuit. Alternatively, a component may be implemented as a piece of software (program). If a piece of software (program) is used, the above-described embodiment can be implemented by, for example, using a general-purpose computer device as basic hardware and causing a processor, such as a central processing unit (CPU), which is mounted on the computer device to run the program.

An embodiment of the present invention has been described above. The embodiment, however, is illustrative only and is not intended to limit the scope of the invention. The new embodiment can be carried out in various other forms, and various omissions, replacements, and changes may be made without departing from the gist of the invention. The embodiment and modifications thereof are included in the scope and gist of the invention and are also included in the invention described in the claims and the scope of equivalents thereof.

A term used in the embodiment should be broadly interpreted. For example, the term “processor” may encompass a general-purpose processor, a central processing unit (CPU), a microprocessor, a digital signal processor (DSP), a controller, a microcontroller, a state machine, and the like. Under some circumstances, the term “processor” may refer to an application-specific integrated circuit, a field programmable gate array (FPGA), a programmable logic device (PLD), or the like. The term “processor” may refer to a combination of a plurality of processing devices, such as a microprocessor, a combination of a DSP and a microprocessor, or one or more microprocessors in conjunction with a DSP core.

As a different example, the term “memory” may encompass an arbitrary electronic component capable of storing electronic information. The term “memory” may refer to a random access memory (RAM), a read-only memory (ROM), a programmable read-only memory (PROM), an erasable programmable read-only memory (EPROM), an electrically erasable PROM (EEPROM), a nonvolatile random access memory (NVRAM), a flash memory, or a magnetic or optical data storage. The memories are processor-readable. If a processor performs reading or writing of information from or to a memory, or both, the memory can be said to electrically communicate with the processor. The memory may be integrated with the processor. Even in this case, the memory can be said to electrically communicate with the processor.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A wireless communication device comprising:
a transmitter configured to transmit a first signal;
a receiver configured to receive a second signal which includes information indicating a transmission channel characteristic at the time of transmission of the first signal; and
a signal processor configured to:
acquire the transmission channel characteristic at the time of transmission of the first signal from the second signal,
estimate a reception channel characteristic at the time of reception of the second signal from the second signal, and
estimate a transmission channel characteristic at a time later than a time associated with the acquired transmission channel characteristic on the basis of the acquired transmission channel characteristic and the estimated reception channel characteristic,
wherein the transmitter transmits a third signal on the basis of the estimated transmission channel characteristic.

2. The wireless communication device according to claim 1, wherein:
the signal processor estimates a transmission channel characteristic variation amount on the basis of the acquired transmission channel characteristic and the estimated reception channel characteristic; and
the signal processor estimates the transmission channel characteristic at the time later than the time associated with the acquired transmission channel characteristic on the basis of the acquired transmission channel characteristic and the estimated transmission channel characteristic variation amount.

3. The wireless communication device according to claim 1, wherein
at least a transmission channel characteristic at a first time and a transmission channel characteristic at a second time are acquired from the second signal,
at least a reception channel characteristic at the first time, a reception channel characteristic at the second time, and a reception channel characteristic at a third time are estimated from the second signal, and
a transmission channel characteristic at the third time is estimated on the basis of the transmission channel characteristics at the respective times and the reception channel characteristics at the respective times.

4. The wireless communication device according to claim 1, wherein
the signal processor determines a transmission scheme for transmitting the third signal on the basis of the estimated transmission channel characteristic, and
the transmitter transmits the third signal by the determined transmission scheme.

5. The wireless communication device according to claim 1, wherein
in a case where the first signal is transmitted via a plurality of first signal subcarriers, and the second signal is transmitted via a plurality of second signal subcarriers,
the signal processor performs:
acquiring, from the second signal, the transmission channel characteristic for the first signal subcarrier at the time of transmission of the first signal;
estimating, from the second signal, the reception channel characteristic for the second signal subcarrier at the time of reception of the second signal;
estimating the transmission channel characteristic for the first signal subcarrier at the time later than the time associated with the acquired transmission channel characteristic for the first signal subcarrier on the basis of the acquired transmission channel characteristic for the first signal subcarrier and the estimated reception channel characteristic for the second signal subcarrier; and
determining a modulation scheme for the first signal subcarriers on the basis of the estimated transmission channel characteristic for the first signal subcarrier, and
the transmitter transmits the third signal via the plurality of first signal subcarriers subjected to modulation by the determined modulation schemes.

6. The wireless communication device according to claim 5, wherein
the signal processor determines the second signal subcarrier corresponding to the first signal subcarrier among the plurality of second signal subcarriers on the basis of a correlation coefficient associated with a transmission channel characteristic variation amount for the first signal subcarriers and a reception channel characteristic variation amount for the second signal subcarriers, the transmission channel characteristic variation amount being based on the acquired transmission channel characteristic for the first signal subcarrier, the reception channel characteristic variation amount being based on the estimated reception channel characteristic for the second signal subcarrier, and
the estimated transmission channel characteristic for the first signal subcarrier is based on the acquired transmission channel characteristic for the first signal subcarrier and the reception channel characteristic for the corresponding second signal subcarrier.

7. The wireless communication device according to claim 6, wherein
a value of the estimated transmission channel characteristic for the first signal subcarrier is calculated by multiplication by at least the correlation coefficient.

8. The wireless communication device according to claim 6, wherein
the signal processor calculates a correlation value for each of the first signal subcarriers by comparing a sequence of the first signal subcarriers with a sequence of the second signal subcarriers, respectively, in order of frequency, and
the correlation coefficient is calculated on the basis of the correlation values calculated for each of the first signal subcarriers.

9. The wireless communication device according to claim 8, wherein
the second signal subcarrier corresponding to the first signal subcarriers is determined among one sequence of the second signal subcarriers, the one sequence of the second signal subcarriers having a correlation coefficient which best meets a condition among correlation coefficients for sequences of the second signal subcarriers, the correlation coefficients for the sequences of the second signal subcarriers being derived by varying the sequence of the second signal subcarriers to be compared with the sequence of the first signal subcarriers.

10. The wireless communication device according to claim 9, wherein
in a case where the transmission channel characteristic variation amount for the first signal subcarriers is estimated at the predetermined times, the second signal subcarrier corresponding to the first signal subcarrier is determined at the predetermined times.

11. The wireless communication device according to claim 8, wherein
the correlation coefficient is an average value of the respective correlation values calculated for the first signal subcarriers compared.

12. The wireless communication device according to claim 6, wherein
when the correlation coefficient falls below a first threshold, the signal processor determines a modulation scheme for the first signal subcarrier associated with the correlation coefficient below the first threshold on the basis of the acquired transmission channel characteristic for the first signal subcarrier.

13. The wireless communication device according to claim 5, wherein
when the estimated transmission channel characteristic variation amount for the first signal subcarriers exceeds a second threshold, the signal processor determines a modulation scheme for the first signal subcarrier associated with the transmission channel characteristic variation amount above the second threshold on the basis of the acquired transmission channel characteristic for the first signal subcarrier.

14. The wireless communication device according to claim 13, wherein
when the number of the first signal subcarriers which are not subject to estimation for the transmission channel characteristic exceeds a predetermined number, the signal processor determines modulation schemes for all of the first signal subcarriers on the basis of the acquired transmission channel characteristic for the first signal subcarrier.

15. The wireless communication device according to claim 13, wherein
the signal processor makes a modulation rate for the first signal subcarrier, the transmission channel characteristic for which is not to be estimated, lower than a predetermined modulation rate.

16. The wireless communication device according to claim 1, wherein
the signal processor performs smoothing on the estimated transmission channel characteristics.

17. The wireless communication device according to claim 1, further comprising
an antenna configured to at least transmit a radio wave associated with the first signal or receive a radio wave associated with the second signal.

18. A wireless communication method comprising:
transmitting a first signal;
receiving a second signal which includes information indicating a transmission channel characteristic at the time of transmission of the first signal;
acquiring the transmission channel characteristic at the time of transmission of the first signal from the second signal;
estimating a reception channel characteristic at the time of reception of the second signal from the second signal;
estimating a transmission channel characteristic at a time later than a time associated with the acquired transmission channel characteristic on the basis of the acquired transmission channel characteristic and the estimated reception channel characteristic; and
transmitting a third signal on the basis of the estimated transmission channel characteristic.
